(19) United States
(12) Patent Application Publication
(10) Pub. No.: US 2008/0003453 A1
(43) Pub. Date: Jan. 3, 2008

(54) Brazing process and composition made by the process

(76) Inventor: John Ogren, Playa Del Rey, CA (US)

Correspondence Address: DUCKOR SPRADLING METZGER & WYNNE;A LAW CORPORATION, 3043 4th Ave., SAN DIEGO, CA, 92103, US

(21) Appl. No.: 11/480,743

(22) Filed: Jul. 3, 2006

(51) Int. Cl. B32B 15/01; B32B 15/18

(52) U.S. Cl. 428/660; 148/528

(57) ABSTRACT

The process of brazing a pair of gamma titanium aluminide articles is disclosed and may include creating an assembly by placing a brazing filler material between and in contact with the pair of gamma titanium aluminide articles and heating the assembly in a furnace to braze the pair of gamma titanium aluminide articles together to form a composition. The composition may include gamma titanium aluminide and stainless steel being formed at a braze joint.

### BACKGROUND OF THE INVENTION

1. Field of the Invention

The present invention relates in general to a process of brazing. It more particularly relates to a process of brazing gamma titanium aluminide, and a composition of matter created using this process.

2. Background Art

There is no admission that the background art disclosed in this section legally constitutes prior art.

Brazing is a joining process whereby a non-ferrous filler metal and an alloy may be heated to melting temperature and distributed between two or more close-fitting parts such as by capillary action. The melted filler metal may interact with a thin layer of the base metal and may be cooled to form an exceptionally strong, sealed joint due to grain structure interaction. The brazed joint may become a sandwich of different layers, each metallurgically linked to each other. Common brazements may be as strong as the materials they join, because the metals may partially dissolve each other at the interface, and the grain structure and joint alloy may be uncontrolled. To create high-strength brazes, sometimes a brazement may be annealed, or cooled at a controlled rate, so that the grain structure of the joint and alloying may be controlled.

There have been a variety of different types and kinds of brazing techniques. For example, reference may be made to the following: U.S. patents and published patent applications U.S. Pat. Nos. 6,190,133; 6,218,026; 6,291,086; 6,387,541; 6,881,439; 2004/0182843; 2004/0223850; and 2004/0094246, as well as articles entitled “Gamma-Met 100 Titanium Aluminide Sheet—Production and Component Fabrication,” Preparing for the Future, Vol. 10 No. 2, August 2000, and “Brazing Filler Material,” http://arris-intl.com/brazing2.html, Oct. 19, 2005.

Gamma titanium aluminide is an advanced material for high temperature applications including high performance jet engine turbine blades. The principal advantage of gamma titanium aluminide may be that at high temperatures the gamma titanium aluminide has a lower density than the current class of materials, known as super alloys, used for various applications such as in jet engine turbine blades, while maintaining a specific strength similar to, and a specific stiffness significantly greater than, that of the super alloys. As a result of this lower density, the centrifugal forces causing creep deformation at high operating temperatures may be reduced for jet engine turbine blades made of gamma titanium aluminide when compared to jet engine turbine blades made of currently used super alloys. The phenomenon of high temperature creep deformation may be a major factor for certain applications in limiting the lifetime of parts such as jet engine turbine blades. Furthermore, gamma titanium aluminide may retain its strength at the higher temperatures, which may be required for certain applications such as for more efficient operation of a jet engine. Therefore, gamma titanium aluminide may be preferable to the super alloys for use in certain high temperature applications due to its lower density, greater specific stiffness, and similar specific strength in comparison to the currently used super alloys.

For example, applications may include air frame components. Such components are the outside surfaces of supersonic aircraft. These are thin sheets or skins which are exposed to the high temperatures (frictional heating) encountered by supersonic aircraft during flight through the air.

Another application may include valves for automobile engines. Valves must move rapidly, and hence, low density is favored. Of course, they must operate at high temperatures. Valves in high-performance race cars must move exceptionally fast, and thus a low density, high temperature material may be important.

Another whole class of applications for gamma titanium aluminide include the so-called stationary or passive parts of a jet engine. These include nozzle flaps, diffusers, and a variety of bearings and structural components that are exposed to high temperatures and should be as low density as possible. Superalloys of various compositions are used currently.

Joining pieces of gamma titanium aluminide has proven to be difficult for certain applications, and complex parts made of gamma titanium aluminide are typically either forged or cast in a single piece. Some believe that some metals, such as titanium, cannot be readily brazed under certain circumstances, because they may be insoluble with other metals or have an oxide layer that forms too quickly at inter-soluble temperatures.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a flow chart of an embodiment of process of joining two pieces of gamma titanium aluminide;

FIG. 2 is a perspective view of a braze joint using the process of FIG. 1 and showing the composition formed at the braze joint; and

FIG. 3 is a photomicrograph at 50× magnification of a braze joint utilizing stainless steel as brazing filler material between two pieces of gamma titanium aluminide.

### DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiments of the invention.

A process and composition of matter are disclosed, and may include a process of brazing a pair of gamma titanium aluminide articles. The process may include creating an assembly by placing a brazing filler material between and in contact with the pair of gamma titanium aluminide articles and heating the assembly in a furnace to braze the pair of gamma titanium aluminide articles together.

In accordance with another disclosed embodiment of the invention, there is provided a composition, which may include gamma titanium aluminide and stainless steel being formed at a braze joint formed between an article of gamma titanium aluminide and stainless steel brazing material.

According to another aspect of a disclosed embodiment of the invention, there is provided a process of brazing a pair of gamma titanium aluminide articles. The process may include creating an assembly by placing a stainless steel brazing material between and in contact with the pair of gamma titanium aluminide articles and heating the assembly in a furnace to a temperature of approximately 1200° C. to braze the pair of gamma titanium aluminide articles together.

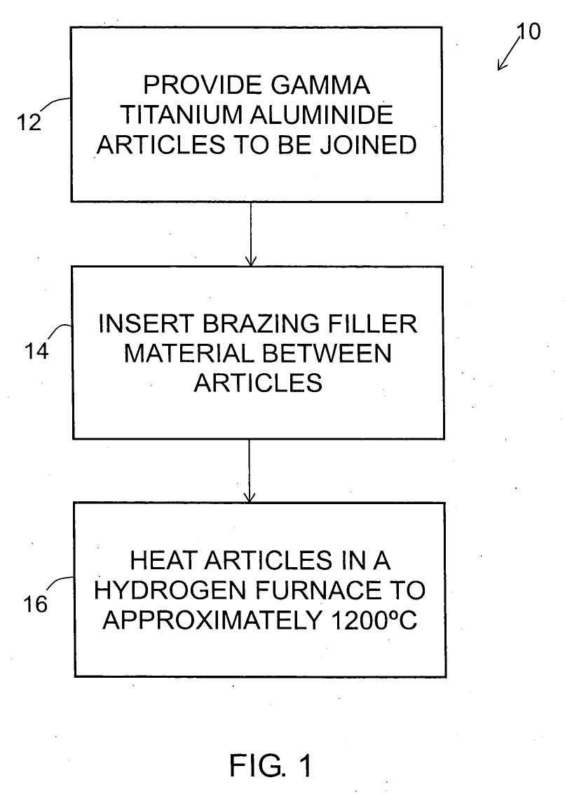

Referring to FIG. 1, an embodiment of the present invention as a process for brazing articles of gamma titanium aluminide is shown, generally referenced as 10. A pair of articles of gamma titanium aluminide to be joined together may be provided at step 12. The gamma titanium aluminide is a long range ordered alloy. The surfaces of the gamma titanium aluminide articles to be joined may be cleaned with a suitable cleaner such as alcohol or an equivalent cleaner, to remove fingerprints, machining/shop oils, paint, or other contaminants. In step 14 a brazing filler material may be placed between and in contact with the pair of gamma titanium aluminide articles at the location where they are to be joined to form an assembly. The brazing filler material may be stainless steel, such as Series 300 stainless steel. The presently preferred stainless steel is Series 304, because an embodiment of the invention was successfully reduced to practice with that filler material.

However, any of the Austenitic Stainless Steels are satisfactory, because they are all essentially 18% Cr-8% Ni-74% Fe with minor additional ingredients that do not substantially affect the braze. The alloys are given numbers such as 302, 304, 316, 321, and 347.

In general, the filler material is refractory. Remaining refractory means that the filler material remain substantially solid at substantially all operating temperatures. The stainless steels, when used for filler material are not heat treatable. That is, they are not strengthened by heat treatment.

The assembly may then be placed into and heated in a furnace as shown in step 16. The environment of the furnace may comprise approximately 50% reducing agent such as hydrogen gas (H₂) and approximately 50% inert gas such as argon gas. It should be understood that other ratios of reducing agent and inert gas may also be employed. The hydrogen gas or other equivalent gas may not harm in a substantial way the mechanical structure of the gamma titanium aluminide articles, and may reduce any oxidation on the assembly within the furnace. The argon gas or other equivalent gas may be used due to its safe and inert characteristics. Other suitable reducing agents such as carbon monoxide or other equivalent reducing agents may also be used in place of the hydrogen gas in the furnace environment to reduce the oxidation. The furnace environment may also be a hard vacuum to reduce the oxidation.

Using the furnace environment, it was observed in an actual tested example that an excellent braze joint was achieved in a hydrogen atmosphere in a material containing titanium. The hydrogen gas, in the actual example, did not destroy the room temperature properties of gamma titanium aluminide, because it is a chemical compound with chemical properties different from either titanium or aluminum. The results of the test were truly unexpected, because hydrogen gas is known to completely embrittle titanium metal and its alloys.

However, room temperature mechanical tests on samples of the compound, gamma titanium aluminide, before and after exposure to the 50% argon gas and 50% hydrogen gas environment show little or no degradation in mechanical properties of the compound.

The actual procedure of the test include evacuating the brazing chamber to a “hard vacuum,” such as greater than about 10⁻⁶ Torr. Alternatively, the brazing chamber may be flushed with, for example, CO gas, and then the 50/50 argon/hydrogen atmosphere can be introduced while the work pieces are at room temperature. Then, the temperature is increased to about 1200° C.

Gamma titanium aluminide has properties different from titanium or aluminum. It was discovered that the gamma titanium aluminide is not embrittled in a hydrogen environment according to an embodiment of the invention.

After placing the assembly in the furnace and obtaining the proper furnace environment, the temperature of the furnace may be raised to approximately 1200° C. and held at that temperature for a predetermined suitable holding time to heat the assembly. For this process the rate at which the temperature in the furnace is increased may not be a critical element to the process allowing the assembly to be heated quickly or slowly depending on the operator's preference or the furnaces limitations. The holding time may be approximately ten minutes, but longer or shorter holding times may also be acceptable. The temperature of the furnace may then be lowered to room or ambient temperature or approximately 22° C. to allow cooling of the assembly in the hydrogen/argon environment of the furnace. The assembly may also be cooled outside the furnace.

An embodiment of the invention was reduced to practice using 1200° C. (2300° F.). The significance of this temperature is that a eutectic temperature exists in the complex multi-constituent system comprising Fe—Cr—Ni—Ti—Al. This eutectic means that the two alloys, even though their individual melting temperatures exceed 1400° C., still form a liquid phase if allowed to contact each other at 1200° C. This effect is similar to the effect where salt is placed on an icy road to “melt” the ice. This “melting” occurs at temperatures below 0° C. Yet, ice by itself must reach 0° C. before it melts and salt by itself must reach about 600° C. In this case, a eutectic mixture of salty water is formed. The cooling rate is not important. The fill material such as stainless steels are not heat treatable.

The pair of gamma titanium aluminide articles may then be bonded together by being metallurgically bonded to the brazing filler material at the braze joint. The strength of the bond between the gamma titanium aluminide articles and the brazing filler material may be substantially that of the gamma titanium aluminide articles, such that the assembly under strain may fail at the gamma titanium aluminide rather than at the braze joint. The brazing procedure of the embodiments of the invention may be used to braze gamma titanium aluminide to other materials provided only that the other materials are compatible with the hydrogen atmosphere in the brazing chamber.

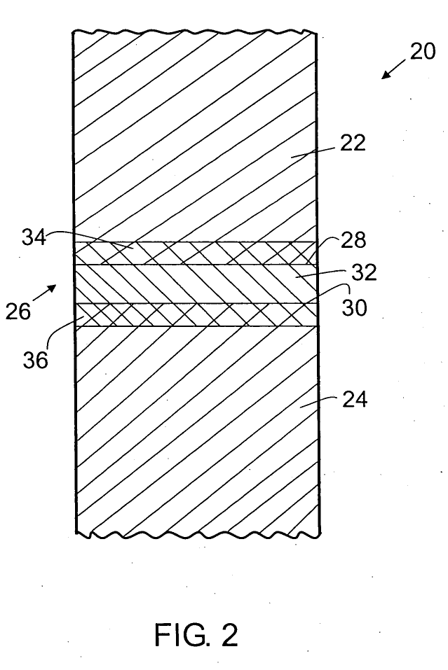

Referring now to FIG. 2, an embodiment of the present invention as a composition of matter is shown using an assembly, generally referenced as 20, of a pair of gamma titanium aluminide articles brazed together using the foregoing described process. The assembly 20 may include a pair of gamma titanium aluminide articles 22 and 24 brazed together at a braze joint 26. The braze joint 26 may be formed utilizing the process described above and may join ends 28 and 30 of the gamma titanium aluminide articles 22 and 24, respectively, using a brazing filler material 32, such as stainless steel as according to the foregoing description. During the brazing process thin layers or zones 34 and 36 at the ends 28 and 30, respectively, of the gamma titanium aluminide articles, may become modified forming a bond by fusing with the brazing filler material 32. The thin layers or zones 34 and 36 may be the composition of matter including gamma titanium aluminide and stainless steel. In an actual example tested, the chemical composition of the brazed joint at zones 34 and 36 were determined to be, by weight, 31% aluminum, 2% titanium, 11% iron, 8% niobium, 4% nickel, and 1% chromium.

Testing performed on assemblies of gamma titanium aluminide articles brazed together using the above process and stainless steel as the brazing filler material, demonstrated that the braze joint may be substantially as strong as the gamma titanium aluminide itself, since the assemblies tended to fail at the gamma titanium aluminide and not at the braze joint.

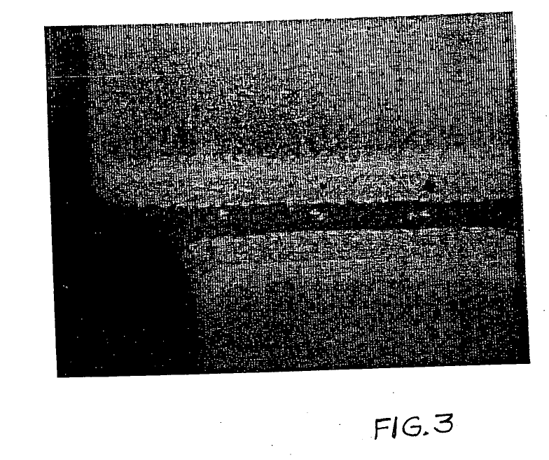

FIG. 3 is a photomicrograph at 50× magnification of a braze joint as described above regarding FIG. 2. As shown in FIG. 3, modified layers or zones 34 and 36 of the gamma titanium aluminide articles 22 and 24 containing the composition of matter may be easily discerned from the gamma titanium aluminide of articles 22 and 24, and the brazing filler material 32.

As used herein, the terms “approximately” and “about” indicate possible variations of plus or minus twenty percent.

While particular embodiments of the present invention have been disclosed, it is to be understood that various different embodiments are possible and are contemplated within the true spirit and scope of the appended claims. There is no intention, therefore, of limitations to the exact abstract or disclosure herein presented.

What is claimed is:

1. A process of brazing a pair of gamma titanium aluminide articles, comprising creating an assembly by placing a brazing filler material between and in contact with the pair of gamma titanium aluminide articles; and
heating the assembly in a furnace to braze the pair of gamma titanium aluminide articles together.

2. The process of claim 1, further comprising:
cooling the assembly in the furnace to approximately room temperature.

3. The process of claim 1, further comprising:
cleaning the pair of gamma titanium aluminide articles.

4. The process of claim 1, wherein heating the assembly in the furnace includes raising the temperature to approximately 1200° C.

5. The process of claim 4, wherein heating the assembly in the furnace includes holding the temperature at approximately 1200° C. for a predetermined period of time.

6. The process of claim 5, wherein the predetermined period of time is approximately ten minutes.

7. The process of claim 5, wherein the temperature is lowered from approximately 1200° C. for cooling purposes.

8. The process of claim 7, wherein the temperature is lowered to about 22° C.

9. The process of claim 1, wherein the furnace contains an environment of approximately 50% reducing agent and approximately 50% inert gas.

10. The process of claim 7, wherein the reducing agent is hydrogen.

11. The process of claim 7, wherein the reducing agent is carbon monoxide.

12. The process of claim 7, wherein the inert gas is argon gas.

13. The process of claim 1, wherein the brazing filler material is stainless steel.

14. The process of claim 1, wherein the stainless steel is a type Series 300 stainless steel.

15. The process of claim 14, wherein the stainless steel is a type 304 stainless steel.

16. The process of claim 1, wherein the furnace contains an environment of approximately 50% carbon monoxide and approximately 50% argon gas.

17. The process of claim 1, wherein the furnace contains a hard vacuum environment.

18. A composition comprising gamma titanium aluminide and stainless steel and being formed at a braze joint formed between an article of gamma titanium aluminide and stainless steel brazing material.

19. The composition of claim 18, wherein the braze joint is formed in a furnace at a temperature of approximately 1200° C.

20. The composition of claim 19, wherein the furnace is held the temperature of approximately 1200° C. for approximately ten minutes.

21. The composition of claim 18, wherein the furnace contains an environment of approximately 50% hydrogen gas and approximately 50% argon gas.

22. The composition of claim 18, wherein the furnace contains an environment of approximately 50% carbon monoxide and approximately 50% argon gas.

23. The composition of claim 18, wherein the furnace contains a hard vacuum environment.

24. The composition of claim 18, wherein the stainless steel brazing material is type 304 stainless steel.

25. A process of brazing a pair of gamma titanium aluminide articles, comprising
creating an assembly by placing a stainless steel brazing material between and in contact with the pair of gamma titanium aluminide articles; and
heating the assembly in a furnace to a temperature of approximately 1200° C. to braze the pair of gamma titanium aluminide articles together.

26. The process of claim 25, wherein the furnace contains an environment of approximately 50% hydrogen gas and approximately 50% argon gas.

27. The process of claim 25, wherein the furnace contains an environment of approximately 50% carbon monoxide and approximately 50% argon gas.

28. The process of claim 25, wherein the furnace contains a hard vacuum environment.

29. The process of claim 25, wherein the stainless steel brazing material is type 304 stainless steel.

30. A composition obtained by a process comprising the steps of
creating an assembly by placing a stainless steel brazing material between and in contact with a pair of gamma titanium aluminide articles; and
heating the assembly in a furnace to a temperature of approximately 1200° C. to braze the pair of gamma titanium aluminide articles together.

31. A composition of claim 30, further including the step of providing a reducing agent and inert gas in a furnace for the heating step.

32. A composition of claim 18, wherein the braze joint is composed of, by weight, 31% aluminum, 2% titanium, 11% iron, 8% niobium, 4% nickel, and 1% chromium.
